(19) United States
(12) Patent Application Publication
(10) Pub. No.: US 2012/0269922 A1
(43) Pub. Date: Oct. 25, 2012

(54) INSERT ASSEMBLY FOR MOLDING OPTICAL FIBER CONNECTOR AND METHOD FOR FABRICATING RELATED OPTICAL FIBER CONNECTOR MOLD

(75) Inventor: CHIA-LING HSU, Tu-Cheng (TW)

(73) Assignee: HON HAI PRECISION INDUSTRY CO., LTD., Tu-Cheng (TW)

(21) Appl. No.: 13/160,516

(22) Filed: Jun. 15, 2011

(30) Foreign Application Priority Data
Apr. 25, 2011 (TW) 100114354

(51) Int. Cl. B28B 21/42; B29C 33/40

(52) U.S. Cl. 425/470; 264/219; 264/109

(57) ABSTRACT

An insert assembly for forming an optical fiber connector is provided. The optical fiber connector includes a light-pervious side wall having a lens portion for optically coupling with an optical fiber, and the lens portion has a flat side surface facing the optical fiber. The insert assembly includes an insert and a spacer. The insert has a side surface and a flat molding surface extending from and coplanar with the side surface, the molding surface configured for molding the flat side surface of the side wall of the optical fiber connector. The spacer has a thicknesswise side surface coplanar with a boundary between the side surface and the molding surface. The thicknesswise side surface of the spacer and the molding surface of the insert are cooperatively configured for molding the side wall of the optical fiber connector. A method for fabricating a related optical fiber connector mold is also provided.

### BACKGROUND

1. Technical Field

The present disclosure relates to molds, and particularly to an insert assembly for molding an optical fiber connector and a method for fabricating a related optical fiber connector mold.

2. Description of Related Art

Optical fiber connectors are widely used in communication. A typical optical fiber connector usually has optical fiber holes in cooperation with other structures, such as L-shaped step structure for guiding and fixing the optical fibers. In the optical fiber connector, a surface facing output ends of the optical fibers needs to have good precision, including low coarseness and precise thickness. Otherwise, there will be an impact on light transmission efficiency.

Current optical fiber connectors are usually formed using an integral mold. That is, a molding surface for molding the surface facing the output ends of the optical fibers is also integrally formed with other portions of the mold. However, with this configuration, it is difficult to machine the molding surface in the mold, and usually, a bottom edge of the molding surface is particularly hard to be machined. Therefore, the precision of the molding surface is not satisfied.

What is needed, therefore, is an insert assembly for molding an optical fiber connector and a method for fabricating a related optical fiber connector mold, which can overcome the above shortcomings.

### BRIEF DESCRIPTION OF THE DRAWINGS

Many aspects of the present insert assembly and method can be better understood with reference to the following drawings. The components in the drawings are not necessarily drawn to scale, the emphasis instead being placed upon clearly illustrating the principles of the present insert assembly and method. Moreover, in the drawings, like reference numerals designate corresponding parts throughout the several views.

FIG. 1 is an optical fiber connector mold in accordance with one embodiment.

FIG. 2 shows an insert assembly used in the optical fiber connector mold of FIG. 1.

FIG. 3 is a disassembled view of the insert assembly of FIG. 2.

FIG. 4 is a schematic view of an optical fiber connector in accordance with one embodiment.

### DETAILED DESCRIPTION

Embodiments of the present insert assembly and method will now be described in detail below and with reference to the drawings.

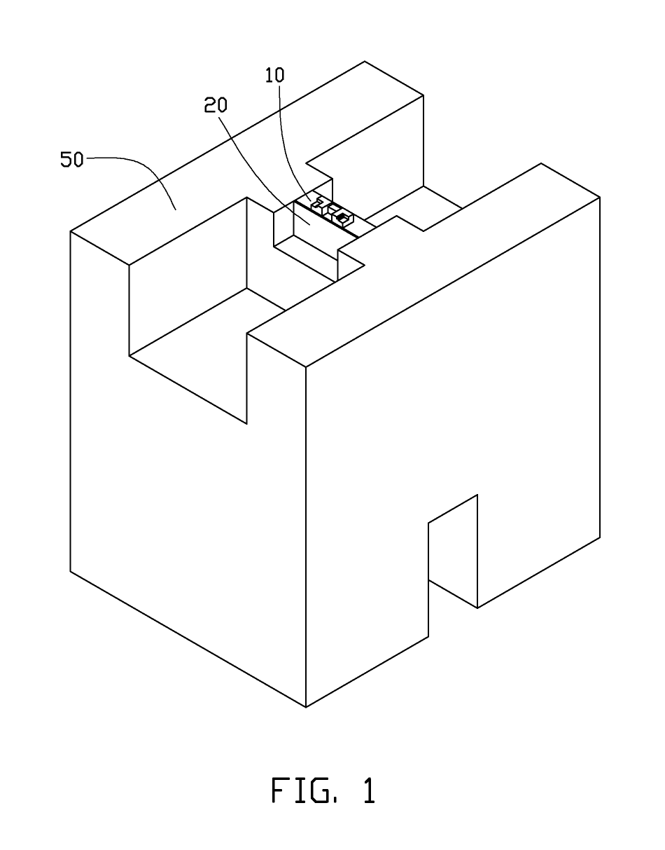

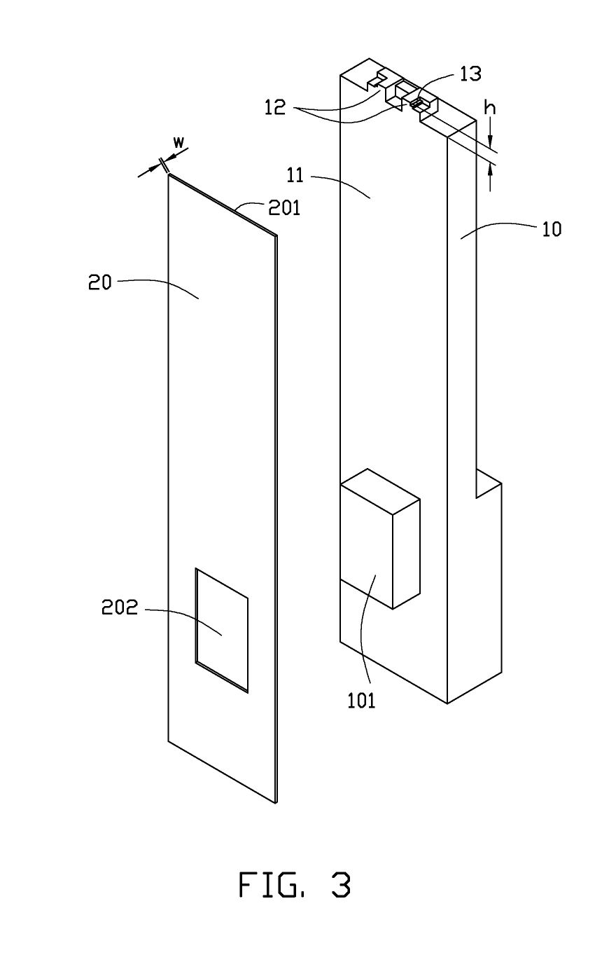

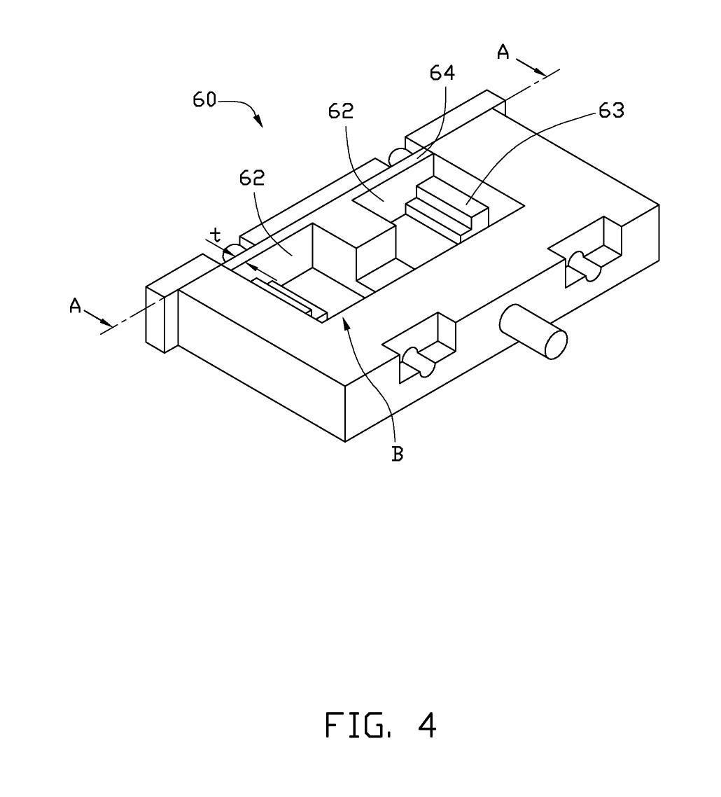

Referring to FIGS. 1 to 4, an optical fiber connector mold includes a mold block 50, and an insert assembly including a plate-shaped insert 10 and a plate-shaped spacer 20 attached to the insert 10. In the present embodiment, the mold block 50 is a core mold block, and can work in cooperation with a cavity mold block to mold an optical fiber connector 60 (see FIG. 4). That is, the mold block 50 is only used for molding a portion of the optical fiber connector 60, which is at the right side of the line A-A. The insert 10 and the spacer 20 contribute to the molding of the optical fiber connector 60. The insert 10 and the spacer 20 are configured for molding only a part of the portion of the optical fiber connector 60, see arrow B in FIG. 4.

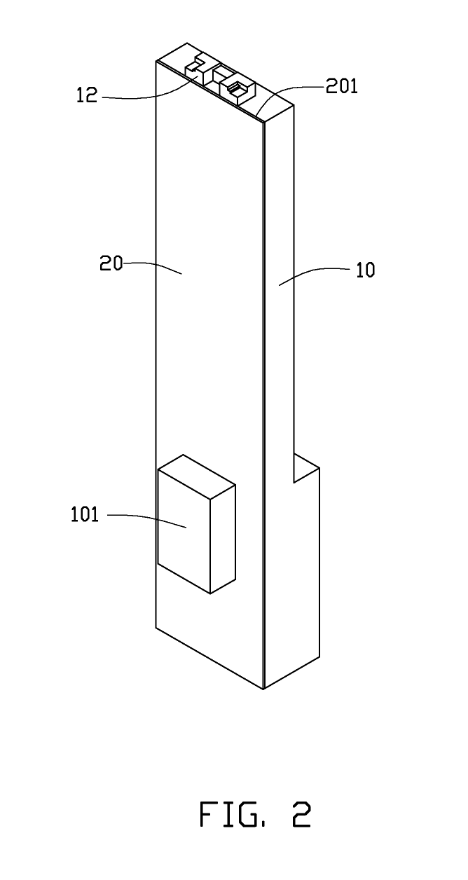

Referring again to FIGS. 1 and 2, the insert 10 includes a side surface 11, and two flat molding surfaces 12 extending from the side surface 11. The molding surfaces 12 are used for molding flat side surfaces 62 (see FIG. 4) facing output ends of at least two optical fibers (not shown). The molding surfaces 12 are processed as the method embodiment hereinafter. The molding surfaces 12 have a film coating, which has a surface flush with the side surface 11. In the present embodiment, the film coating is a is a nickel film coating, and the film coating has a thickness about 25 micrometers, and the molding surfaces 12 each have a height h about 0.7 millimeters.

A substantially L-shaped step 13 is arranged adjacent to the molding surfaces 12, and is configured for molding an L-shaped step structure 63 of the optical fiber connector 60.

The side surface 11 defines a chuck 101. The spacer 20 defines a trough 202 therein. The spacer 20 is attached to the side surface 11 of the insert 10 through the chuck 101 engaged in the trough 202, and a thicknesswise side surface 201 of the spacer 20 is flush (coplanar) with a boundary between the side surface 11 and the molding surfaces 12. The molding surfaces 12 are substantially perpendicular to the thicknesswise side surface 201. The thicknesswise side surface 201 of the spacer 20 and the molding surfaces 12 of the insert 10 are cooperatively configured for molding a light-pervious side wall 64 of the optical fiber connector 60, where the flat side surfaces 62 facing the optical fibers are located (see FIG. 4).

A thickness w of the thicknesswise side surface 201 is equal to a thickness t of the flat side wall 64. In the present embodiment, the thickness w and the thickness t are both about 0.12 millimeters.

A method for fabricating the optical fiber connector mold includes the following steps.

First, an insert 10 and a spacer 20 are provided. The insert 10 has a side surface 11. Then, an end portion of the side surface 11 is mirrored into the molding surfaces 12 for molding the flat side surfaces 62 facing the output ends of optical fibers. The molding surfaces 12 are flush with the side surface 11, and extend away from the side surface 11.

In detail, the mirroring process may include the following steps.

First, machining the end portion of the side surface 11 to decrease an initial thickness of the end portion of the side surface 11, for example 25 micrometers.

Second, forming a film coating on the machined end portion of the side surface 11, a thickness of the film coating is a little greater than a decreased amount of the thickness of the end portion of the side surface 11, for example 30 micrometers.

Third, mirroring the film coating to remove a top portion of the film coating, which is greater than the decreased thickness amount, i.e., to remove 5 micrometers to form the molding surfaces 12. A precise processing machine having a diamond cutter carries out the mirroring process. The diamond cutter is flat and has a circular end, and the circular end has radius R about 50 millimeters. After the mirroring process, the molding surfaces 12 has a film coating which is coplanar with the side surface 11, and the molding surfaces 12 each have a mirror effect.

After the mirroring process, the spacer 20 is attached to the insert 10 to form the insert assembly, the thicknesswise side surface 201 is flush with the boundary between the side surface 11 and the molding surfaces 11. Then, the insert assembly is inserted into the mold block 50 to form a molding chamber to form the optical fiber connector. The molding surfaces 12 of the insert 10 in cooperation with the thicknesswise side surface 201 of the spacer 20 are configured for molding the light-pervious flat side wall 64 where the flat side surfaces 62 located, and where the output ends of the optical fibers face. The other portions of the insert 10 help to form the portion of the optical fiber connector 60 where the B in FIG. 4 is designated.

As the spacer 20 can be detached from the insert 10, such that the molding surfaces 12 of the insert 10 can be machined freely without any obstruction, and therefore, the precision of the molding surfaces 12 can be satisfied. With the method of present embodiment, the coarseness of the molding surfaces 12 can be as low as 20 nanometers, and the thickness of the flat side wall 64 can be controlled precisely. In this way, light transmission efficiency of the optical fiber connector is improved.

In addition, due to the spacer 20, abrasion of the molding surfaces 12 of the insert 10, during assembly in the mold block 50 can be avoided.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An insert assembly for forming an optical fiber connector, the optical fiber connector including a light-pervious side wall, the side wall having a lens portion for optically coupling with an optical fiber, the lens portion having a flat side surface facing the optical fiber, the insert assembly comprising:
a plate-shaped insert having a side surface and a flat molding surface extending from and coplanar with the side surface, the molding surface configured for molding the flat side surface of the side wall of the optical fiber connector; and
a plate-shaped spacer for attachment to the side surface of the insert, the spacer having a thicknesswise side surface coplanar with a boundary between the side surface and the molding surface, the thicknesswise side surface of the spacer and the molding surface of the insert cooperatively configured for molding the side wall of the optical fiber connector.

2. The insert assembly of claim 1, wherein the molding surface is substantially perpendicular to the thicknesswise side surface.

3. The insert assembly of claim 2, wherein the insert includes a nickel film coating formed on the molding surface.

4. The insert assembly of claim 1, wherein a thickness of the thicknesswise side surface of the spacer is equal to a thickness of the side wall of the optical fiber connector.

5. The insert assembly of claim 1, wherein the insert has a chuck formed on the side surface, and the spacer has a trough formed therein, the chuck engaged in the trough.

6. A method for fabricating an optical fiber connector mold, comprising:
providing an insert assembly of claim 1;
mounting the spacer to the side surface of the insert in a manner that the thicknesswise side surface of the spacer is flush with a boundary between the side surface and the molding surface; and
placing the assembled insert assembly into a mold block, the mold block and the insert assembly cooperatively forming a molding chamber to form an optical fiber connector mold.

7. The method of claim 6, wherein the insert has a chuck formed on the side surface, and the spacer has a trough formed therein, the chuck engaged in the trough.

8. The method of claim 6, wherein the molding surface is machined using a mirroring process, the mirroring process comprising:
machining an end portion of the side surface of the insert, such that the initial thickness of the insert is decreased;
forming a film coating on the machined end portion of the side surface, the film coating having a thickness greater than a decreased amount of the insert; and
mirroring the film coating using a precise processing machine having a diamond cutter to remove a top portion of the film coating, thereby obtaining the molding surface coplanar with the side surface of the insert.

9. The method of claim 8, wherein the film coating is a nickel film coating.
